(19) United States
(12) Patent Application Publication
(10) Pub. No.: US 2025/0308874 A1
(43) Pub. Date: Oct. 2, 2025

(54) MEASUREMENT SYSTEM AND METHOD FOR DETERMINING A SAMPLE CHARACTERISTIC

(71) Applicants: PORTOLAB B.V., Maastricht (NL); SMART SENSORS HOLDING B.V., Maastricht (NL)

(72) Inventors: Sarfarazuddin Ahmed Hashmi SYED, Maastricht (NL); Cornelis VAN GORSEL, Maastricht (NL)

(21) Appl. No.: 18/864,682

(22) PCT Filed: Mar. 28, 2023
(86) PCT No.: PCT/EP2023/057950

§ 371 Date: Nov. 11, 2024

(30) Foreign Application Priority Data
May 12, 2022 (NL) 2031837

(51) Int. Cl. H01J 49/04; H01J 49/00; H01J 49/24

(52) U.S. Cl. CPC H01J 49/049; H01J 49/0031; H01J 49/24

(57) ABSTRACT

A measurement system for determining a presence of a chemical substance in a sample. The chemical substance may refer to a simple chemical material or a chemical composition of several compounds. A method for determining a presence of a chemical substance in a sample wherein use is made of the measurement system.

### FIELD OF THE INVENTION

The invention relates to a measurement system for determining a presence of a chemical substance in a sample. The chemical substance may refer to a simple chemical material or a chemical composition of several compounds. The invention further relates to a method for determining a presence of a chemical substance in a sample wherein use is made of a measurement system according to the invention.

### BACKGROUND OF THE INVENTION

Analytical spectrometry, e.g. mass spectrometry, is an analytical technique that may be used to detect the presence of a chemical substance of a sample of interest by measuring the mass-to-charge ratio, i.e. the molecular mass, of components of the sample. Analytical spectrometry may be applied for the detection of drugs, explosives and food contaminants.

For example, measurement systems for rapid detection are in demand in the security market for screening of risk related substances. For example, these measurement systems may be used on commercial airports or police laboratories to detect for illegal and/or dangerous substances. For example, airport security uses sensors to scan luggage of travellers for the presence of drugs. If such a scan gives a positive result the passenger may be detained and/or arrested.

In another example, measurement systems are in demand in health and food industries. In particular, measurement systems that allow to measure characteristics, such as a presence of potentially dangerous components and/or contaminants, in medicine or food products are needed. For example, a portable measurement system may save time and/or be more convenient for detecting the presence of potentially dangerous components compared to having to bring the sample to a lab.

In most instances, e.g. in cases where many samples have to be tested, a fast throughput time of the sample in the measurement system is preferred. For example, a faster throughput time allows to measure luggage of more travellers.

### SUMMARY OF THE INVENTION

It is an object of the first aspect of the invention to provide a measurement system which allows to reduce time between collecting a sample and providing a presence of a chemical substance.

The object of the invention is achieved by a measurement system for determining a presence of a chemical substance in a sample, wherein the measurement system comprises a sample holder for holding the sample therein and a measurement device, wherein a magnetizable sample evaporator is provided in the sample holder, and wherein the sample holder has an opening in a top side thereof for providing the sample to the sample holder in contact with the sample evaporator,
wherein the measurement device comprises:
a sample chamber with an electromagnetic coil for placing the sample holder holding the sample in a center of the electromagnetic coil;
electronic means for providing an alternating electric current to the electromagnetic coil;
a vacuum chamber adjacent to the sample chamber, wherein the vacuum chamber is configured for comprising a vacuum;
sample transfer means for connecting the sample chamber to the vacuum chamber, wherein the sample transfer means comprise a separator provided between the vacuum chamber and the sample chamber for separating the vacuum chamber from the sample chamber, wherein the separator is porous to the evaporated sample, wherein the sample transfer means are configured to allow the evaporated sample to flow from the sample holder through the separator to the vacuum chamber;
a sample ionizer for ionizing the sample, which sample ionizer is provided in the vacuum chamber;
an analytical spectrometry sensor provided in the vacuum chamber for determining a first sample property of the sample by performing a measurement on ionized evaporated sample in the vacuum chamber; and
a processor connected to the electronic means for controlling the alternating electric current provided to the electromagnetic coil and connected to the spectrometry sensor for receiving the first sample property and determining the presence of the chemical substance in the sample based on the first sample property,
wherein the measurement system is configured to:
receive a sample in the sample holder and receive the sample holder in the sample chamber;
provide the alternating electric current to the electromagnetic coil such that the electromagnetic coil generates a magnetic field heating the sample evaporator, evaporating a portion of the sample in the sample holder in contact with the sample evaporator;
transfer the evaporated sample through the sample transfer means to the spectrometry sensor in the vacuum chamber;
ionize the evaporated sample with the sample ionizer;
measure the evaporated sample with the spectrometry sensor to determine the first sample property;
determine the presence of the chemical substance in the sample by the processor based on the first sample property; and
output, by the processor, the determined chemical substance.

The measurement system of the invention is configured for determining a presence of a chemical substance in a sample, e.g. a predetermined chemical substance. The sample may be a sample in powder form, liquid form, or solid form. For example, the measurement system may determine the presence of a certain chemical substance in the sample, such as a drug, e.g. like heroin or cocaine, or the presence of a contaminant in a food product. The measurement system may further be configured to determine a concentration of such a chemical substance in the sample. The measurement system may further be configured to determine the presence of multiple chemical substances in the sample such as the presence of multiple type of drugs.

The measurement system of the first aspect comprises a sample holder for holding the sample. The sample holder may be embodied as a removable sample holder, e.g. in the form of a vial or other standard sample holder. The sample holder may also be integrated with the measurement device, e.g. as a container in the measurement device for receiving the sample. A magnetisable sample evaporator, such as a metal sample evaporator, is provided in the sample holder in contact with the sample when the sample is received by the sample holder. The sample holder has an opening in a top side thereof for providing the sample to the sample holder in contact with the sample evaporator. For example, the sample holder may be a vial or bottle having a top side opening. The opening of the sample holder may serve to allow sample, e.g. vaporized sample, to escape the sample holder and move to the mass spectrometer through the separator.

The sample holder may be provided with the measurement device as a kit so that the sample holder neatly fits into the sample chamber.

The measurement system of the first aspect further comprises a measurement device for receiving the sample holder, in case the sample holder is removable from the measurement device, or for receiving the sample, in case the sample holder is integrated with the measurement device.

The measurement device of the first aspect comprises a sample chamber for placing the sample holder containing the sample therein. The sample holder may also be integrated into the sample chamber. The sample chamber comprises an electromagnetic coil, for example embodied as a regular or flat solenoid, that surrounds the sample holder when the sample holder is placed in the sample chamber such that the sample holder is in a centre of the electromagnetic coil. The sample chamber may be a cavity in the device comprising a wall, e.g. an openable wall, e.g. an openable top wall, for opening and closing the sample chamber, allowing the sample holder to be placed in and removed from the sample chamber.

Electronic means are provided for providing an alternating electric current to the electromagnetic coil. By providing the alternating electric current to the electromagnetic coil a magnetic field is generated by the coil, which magnetic field penetrates the sample evaporator in the sample holder. The magnetic field causes the circulation of Foucault's currents in the sample evaporator which leads to a heating of the sample evaporator which in turn leads to evaporation of sample in the sample holder. By controlling the frequency and amplitude of the electric voltage or current, the temperature of the sample evaporator and thus rate of evaporation of the sample may be controlled.

The measurement device of the first aspect further comprises a vacuum chamber adjacent to the sample chamber configured for comprising a vacuum, for example configured for having a pressure between 10⁻³ and 10⁻⁸ mbar.

The measurement device of the first aspect further comprises evaporated sample transfer means for connecting the sample chamber to the vacuum chamber. The transfer means comprise a separator provided between the vacuum chamber and the sample chamber, for separating the vacuum chamber from the sample chamber, wherein the separator is porous to the evaporated sample, wherein the sample transfer means are configured to allow the evaporated sample to flow from the sample holder through the separator to the vacuum chamber. The sample transfer means allow a portion of the sample, to be measured by the spectrometry sensor, to be transferred from the sample holder to the vacuum chamber for measurement. The sample transfer means may transfer the sample passively, e.g. by vaporizing, or actively, e.g. by using some pump mechanism.

The separator may be provided at a distance between 0 mm and 50 mm from an opening in the sample holder when the sample holder is provided in the sample chamber.

The sample transfer means may comprise a membrane probe, e.g. as part of the separator, which allows evaporated sample to enter into the sample transfer means. The membrane probe may be provided adjacent, e.g. in contact with, an opening of the sample holder to allow the evaporated sample to directly flow into the sample transfer means from the sample holder. The membrane probe may comprise a mesh and a tube. The separator may be connected to a needle valve to connect the vacuum chamber to the sample chamber. The membrane probe may be manufactured of PDMS, PFTE or any other suitable material.

In embodiments of the first aspect, the separator is heat able by heating means, e.g. to at least 80° C., preferably to at least 100° C., more preferably to 220° C. This may prevent non-volatile samples to precipitate on the separator. In case the sample is a volatile sample, the separator may be at room temperature.

The measurement device of the first aspect further comprises a sample ionizer for ionizing the sample in the vacuum chamber. For example, the sample ionizer may ionize the sample by providing a large voltage over the sample. The ionizer may further be an electron impact or heat ionization or laser.

The measurement device of the first aspect comprises an analytical spectrometry sensor provided in the vacuum chamber for determining, via a measurement, of a first sample property of the sample by performing a measurement on ionized sample in the vacuum chamber. For example, the analytical spectrometry sensor may be a mass spectrometer, e.g. having a pre-filter, ion guide or post filter. The mass spectrometer may be a quadrupole mass spectrometer, time of flight mass spectrometer, ion trap mass spectrometer, Fourier transform mass spectrometer or magnetic sector mass spectrometer.

The measurement device also comprises a processor connected to the electronic means for controlling the alternating electric current provided to the electromagnetic coil and connected to the spectrometry sensor for receiving the first sample property and determining the presence of the chemical substance based on the first sample property.

The measurement system of the first aspect is configured to:
receive a sample in the sample holder and receive the sample holder in the sample chamber;
provide the alternating electric current to the electromagnetic coil such that the electromagnetic coil generates a magnetic field heating the sample evaporator, evaporating a portion of the sample in the sample holder in contact with the sample evaporator;
transfer the evaporated sample through the sample transfer means to the spectrometry sensor in the vacuum chamber;
ionize the evaporated sample with the sample ionizer;
measure the evaporated sample with the spectrometry sensor to determine the first sample property;
determine the presence of the chemical substance in the sample by the processor based on the first sample property; and
output, by the processor, the determined chemical substance.

For example, the first sample property may be a mass spectrum of the sample obtained by the spectrometry sensor.

The measurement device of the first aspect allows for a rapid heating and evaporating of the sample in the sample holder by making use of the creation of the alternating magnetic field which leads to inductive heating of the sample evaporator. This allows samples to be evaporated between 1 second to 120 seconds depending on the alternating current or voltage applied to the coil. By using this method of evaporating, the measurement system allows to reduce time between collecting a sample and providing a determined presence of the chemical substance compared to known systems using conventional evaporating methods.

In embodiments of the first aspect, the sample evaporator comprises one or more, e.g. three, supporting legs supporting a magnetizable evaporator dish which evaporator dish is separated from a bottom of the sample holder by the supporting legs, wherein the sample evaporator allows a portion of sample received by the sample holder to be placed on the evaporator dish, e.g. wherein the sample evaporator is a free-standing sample evaporator, e.g. wherein the evaporator dish has a smaller cross section than the sample holder. This embodiment allows for a small portion of the sample to be in contact with the evaporator, thus allowing for more efficient evaporation. Furthermore, another portion of the sample may not be evaporated and may be stored in the sample holder for later use. Additionally, this embodiment allows a user to deposit sample into the sample holder by letting sample fall into the sample holder, which allows some sample to fall onto the evaporator dish and some sample to fall to the bottom of the sample holder. Thus, a desired portion of the sample may be automatically provided on the evaporator dish, e.g. depending on the dimensions of the dish, and no precise placement of the sample on the evaporator dish is required. The supporting legs may have a smaller cross section compared to the evaporator dish. This allows the supporting legs to have little contact with the sample in the sample holder, leading to relatively little sample to be evaporated due to contact with the legs compared to the sample being evaporated by the evaporator dish. In embodiments, the supporting legs are manufactured from a nonconducting material and only the evaporator dish is magnetizable.

In embodiments of the first aspect, the sample holder comprises a sample vial, e.g. a glass sample vial, e.g. a removable glass sample vial, for containing the sample and the sample evaporator. For example, the sample vial may be provided with the measurement system in the form of a kit such that the sample vial neatly fits into the sample chamber.

In embodiments of the first aspect, the electronic means for providing an alternating electric current to the electromagnetic coil comprises a power supply, an electronic oscillator and a capacitor. In particular, the electronic means should be configured for providing the required alternating electric current to evaporate the sample of interest.

In embodiments of the first aspect, the measurement device further comprises a heater for heating the separator, e.g. preferably for heating the separator to at least 80° C., more preferably to at least 100° C. It was found that for common samples, e.g. non-volatile samples, heating the heatable separator to at least 80° C., preferably to at least 100° C., more preferably to 220° C., prevents the sample from forming on the separator preventing the sample to flow to the vacuum chamber. Depending on the properties (volatile, semi volatile or non-volatile) of the sample material the heatable separator can have temperature ranges from room temperature to up to 220° C.

In embodiments of the first aspect, the separator comprises a membrane probe comprising a membrane and a porous metal mesh, preferably having openings with a size in the range of 10 micrometer to 100 micrometer. The membrane probe allows for a controlled leak to the vacuum chamber, allowing sample to flow thereto while maintaining sufficient vacuum, e.g. under the influence of a vacuum pump. For example, the separator may comprise a membrane probe, e.g. a PDMS membrane in combination with a metal mesh, which is configured to control a flow of sample from the sample chamber to the vacuum chamber. For example, the control leak valve may be provided between the membrane probe and the vacuum chamber which has an opening having a diameter between 0.5 mm and 1 mm. Instead of a control leak valve, it is possible that an opening is provided between the membrane probe and the vacuum chamber.

In embodiments of the first aspect, the analytical spectrometry sensor is one of a mass spectroscopy sensor, a gas chromatogram sensor, and a gas chromatogram- mass spectrum sensor.

In embodiments of the first aspect, the measurement device further comprises an optical sensor provided adjacent to the sample chamber, e.g. underneath the sample chamber, for determining a second sample property by measuring the sample in the sample holder, wherein the processor is configured for receiving the second sample property and for determining the presence of the chemical substance in the sample based on the first sample property and the independently determined second sample property. The optical sensor may be one of an infrared sensor, a Raman spectroscopy sensor, an ultraviolet-visible spectroscopy sensor, and a hyperspectral spectroscopy sensor. The type of optical sensor may be chosen based on the type of sample measurement requirements, which may depend on sample features such as: transmittance, interactance, transflectance, diffuse transmittance, and diffuse reflectance. This embodiment allows to reduce the time between taking a sample and providing two independent tests for determining a presence of the chemical substance. This embodiment is particularly advantageous for use of detection of substances for which two independent tests are required, e.g. for contraband substances, e.g. at airports.

The second sample property may be determined based on the reflection of the irradiated light, for example based on detected frequencies of infrared light that are absorbed by molecules of the sample. For example, the optical sensor may be based on near infrared spectroscopy wherein compounds in the sample are detected based on detected frequencies of infrared light that are absorbed and emitted by molecules in the sample. The second sample property may be related to chemical structure of the sample, e.g. to determining the presence of a molecule in the sample based on the absorption of the light, e.g. the presence of a cocaine molecule in the sample. In particular, the first sample property and the second sample property may be determined simultaneously.

The first aspect further relates to a method for determining a presence of a chemical substance, e.g. a predetermined chemical substance, in a sample, wherein use is made of a measurement system according to the invention.

In embodiments of the method of the first aspect, the method comprises:
providing a sample in the sample holder and providing the sample holder in the sample chamber;
providing the alternating electric current to the electromagnetic coil such that the electromagnetic coil generates a magnetic field heating the sample evaporator, evaporating a portion of the sample in the sample holder in contact with the sample evaporator;
transferring the evaporated sample through the sample transfer means to the spectrometry sensor in the vacuum chamber;
ionizing the evaporated sample with the sample ionizer;
measuring the evaporated sample with the spectrometry sensor to determine the first sample property;
determining the presence of the chemical substance in the sample by the processor based on the first sample property; and
output, by the processor, the determined chemical substance.

In embodiments of the method of the first aspect, use is made of a measurement system wherein the sample evaporator comprises three supporting legs supporting a magnetizable evaporator dish which evaporator dish is separated from a bottom of the sample holder by the supporting legs, wherein the sample evaporator allows a portion of sample received by the sample holder to be placed on the evaporator dish, e.g. wherein the sample evaporator is a free-standing sample evaporator, wherein the further comprises: placing a portion of the sample received by the sample holder on the evaporator dish.

In embodiments of the method of the first aspect, use is made of a measurement system wherein the measurement device further comprises an optical sensor provided adjacent to the sample chamber, e.g. underneath the sample chamber, for determining a second sample property by measuring the sample in the sample holder, wherein the processor is configured for receiving the second sample property and for determining the presence of the chemical substance in the sample based on the first sample property and the independently determined second sample property, wherein the method further comprises:
measuring the sample in the sample holder with the optical sensor to determine the second sample property, wherein the measurement with the optical sensor is preferably performed simultaneously with the measurement of the spectrometry sensor; and
determining the presence of the chemical substance in the sample by the processor based on the first sample property and the second sample property.

The first aspect further relates to a method for determining a presence of a chemical substance, e.g. a drug, e.g. at an airport or police laboratory in a sample, wherein use is made of a measurement system according to the invention and/or the method according the invention.

A second aspect of the application relates to a measurement device which allows a single sample to be measured by two simultaneous and independent measurements. Each measurements relates to a respective test for testing a presence of the substance. Each of the two measurements determines a presence of the chemical substance in the sample which is received by the processor for determining the presence of the chemical substance in the sample based on these properties. Thus removing the need to wait for the results of a second test after performing the first test and reducing the time between collecting the sample and providing the two independent tests for determining the presence of the chemical substance in the sample.

The measurement device of the second aspect is configured to determine a presence of a chemical substance in a sample that is contained in a sample holder having an opening. The chemical substance may be a chemical substance provided on a list, e.g. a list provided to the measurement device. For example, the sample holder may be a vial or bottle having a top side opening. The opening of the sample holder may serve to allow sample, e.g. vaporized sample, to escape the sample holder and move to the second sensor through the separator. The sample holder may be provided with the measurement device as a kit so that the sample holder neatly fits into the sample chamber.

The measurement device of the second aspect is configured to be able to perform at least two simultaneous measurements. The measurements may be performed simultaneous to each other, meaning that the two measurements, and thus the two tests, may be performed simultaneously on the same sample.

The measurement device of the second aspect comprises a sample chamber for placing the sample holder containing the sample. The sample chamber may be a cavity in the device comprising a openable wall for opening and closing the sample chamber allowing the sample holder to be placed in and removed from the sample chamber.

The measurement device of the second aspect further comprises a first sensor for performing a first measurement on the sample in the sample holder. The first sensor is configured for determining a first sample property using the first measurement. The first sensor is an optical sensor, i.e. a sensor relying on optical techniques to measure the first property, that is provided adjacent to the sample chamber. For example, the first sensor may be provided such that an opening or a window of the sample chamber allows the optical sensor, e.g. the light thereof, to measure the sample in the sample chamber.

The first sensor determines the first sample property based on optical properties of the sample. The first sample property is indicative of the presence of the chemical substance. For example, the first sensor may be based on infrared measurement techniques whereby the sample is irradiated with infrared light. The first property may then be determined based on the reflection of the irradiated light, for example based on detected frequencies of infrared light that are absorbed by molecules of the sample. For example, the first sensor may be based on near infrared spectroscopy wherein compounds in the sample are detected based on detected frequencies of infrared light that are absorbed and emitted by molecules in the sample. The first property may be related to chemical structure of the sample, e.g. to determining the presence of a molecule in the sample based on the absorption of the light, e.g. the presence of a cocaine molecule in the sample.

The measurement device of the second aspect further comprises a sample ionizer provided in the vacuum chamber for ionizing the sample. The sample ionizer may ionize the sample by providing a large voltage to the sample.

The measurement device of the second aspect further comprises a vacuum chamber configured for comprising a vacuum. The vacuum chamber has an opening that is provided in a wall of the sample chamber. In embodiments, the opening is provided in an upper wall of the sample chamber. The opening between the vacuum chamber and the sample chamber allows sample, e.g. vaporized or ionized sample, to drift from the sample chamber to the vacuum chamber.

The measurement device of the second aspect further comprises sample transfer means comprising a heatable separator provided between the vacuum chamber and the sample chamber, for separating the vacuum chamber from the sample chamber, wherein the heatable separator is porous to the sample, wherein the sample transfer means are configured for transferring a portion of the sample from the sample holder through the separator to the vacuum chamber. Heating means are provided to heat the heatable separator.

The sample transfer means are configured for transferring a portion of the sample from the sample holder through the separator to the vacuum chamber. The sample transfer means allow a portion of the sample, to be measured by the second sensor, to be transferred from the sample holder to the vacuum chamber for measurement. The sample transfer means may transfer the sample passively, e.g. by vaporizing, or actively, e.g. by using some pump mechanism.

The heatable separator allows the sample to go from the sample holder to the vacuum chamber by a controlled leak from the sample chamber to the vacuum chamber, e.g. without destroying the vacuum in the vacuum chamber. The separator is heated to prevent sample from forming on the separator, for example to prevent vaporized sample to reconversion from vapor to liquid or solid form. The separator may be provided at a distance of 0.5 mm to 10 cm, preferably at 2 cm, from the opening of the sample holder when the sample holder is placed in the sample chamber.

The separator may control a leak to the vacuum chamber from the sample chamber by a control leak valve or an opening. The separator may block moisture from entering the vacuum chamber to prevent damage to the vacuum chamber and/or the second sensor.

The measurement device of the second aspect further comprises a second sensor for performing a second measurement on ionized sample in the vacuum chamber and for determining a second sample property. The second sample property is indicative of the presence of the chemical substance. The ionized sample is ionized by the sample ionizer. The second sensor is an analytical spectrometry sensor, such as a mass spectrometry sensor, provided in the vacuum chamber, which may detect the presence of compounds of interest, e.g. drugs or explosives, based on the molecular weight thereof. The second sensor allows a second, independent from the first, test to be performed on the sample. The sample may be measured by the first sensor while a portion of the sample is transferred to the vacuum chamber and measured by the second sensor. The second sensor may detect the presence of the chemical substance based on mass-to-charge ratio of the ionized sample.

The measurement device of the second aspect further comprises a processor connected to the first sensor and the second sensor for receiving the first sample property and the second sample property. The processor is configured for receiving the first sample property and the second sample property and determining the presence of a chemical substance in the sample based on the first sample property and the second sample property. The presence of the chemical substance is determined when both the first sample property and the second sample property indicate the presence of the chemical substance. For example, if the first sample property and the second sample property are indicative of cocaine, the processor may determine that the sample is or contains cocaine. For example, if the first property and the second property are contradictory for determining a presence of the substance in the sample, the processor determines that the presence of the substance in the sample may not be determined based on the first and second properties. The processor may show the determined characteristic on a display, e.g. on the request of an operator.

The measurement device of the second aspect comprises a heater for heating and vaporizing the sample contained in the sample holder located in the sample chamber, wherein the heatable separator is porous to the vaporized sample. In embodiments, the heater may be a metal or ceramic heater. Preferably, the heater is configured such that sample may not stick to the surface thereof. For example, the heater is provided outside of the sample chamber adjacent to a wall thereof. By vaporizing the sample, the sample may be transferred through the separator, e.g. under the effect of diffusion. In this embodiment, the sample ionizer may be provided to ionize the sample in the sample chamber or in the vacuum chamber.

The measurement device of the second aspect is configured to:
receive the sample in the sample holder and receive the sample holder in the sample chamber;
vaporize a portion of the sample with the heater and transfer the vaporized sample to the vacuum chamber with the sample transfer means;
simultaneously measure the first sample property with the first sensor and the second sample property with the second sensor; and
determine the presence of the chemical substance in the sample based on the first sample property and the second sample property, wherein the presence of the chemical substance is determined when both the first sample property and the second sample property indicate the presence of the chemical substance.

In embodiments of the measurement device of the second aspect, the sample transfer means further comprises a sample ionizer, wherein the sample ionizer is configured to ionize the sample in the sample holder, and wherein the heatable separator comprises an ambient ionization probe for providing an electric potential to transfer the ionized sample from the sample chamber to the vacuum chamber. In this embodiment the sample is transferred to the vacuum chamber by ionizing the, portion of, sample and then transferring the sample under the influence of an electric potential, e.g. an electric field, through the separator which comprises an ambient ionization probe for providing the electric potential. For example, the ambient ionization probe may be a paperspray or an electrospray. For example, in this embodiment the separator may comprise a capillary with a diameter between 0.08 mm and 0.13 mm.

In embodiments of the second aspect, the separator may further comprise an intermediate vacuum region between the sample chamber and the vacuum chamber. For example, the vacuum chamber, intermediate vacuum chamber and the sample chamber are separated by orifice, for example having diameter of 1 mm. The vacuum in the intermediate vacuum chamber may be between 1mbar and 2mbar.

In an embodiment of the measurement device of the second aspect the heatable separator comprises a heatable membrane probe comprising a membrane and a porous metal mesh, preferably having openings with a size in the range of 10 micrometer to 100 micrometer. The heatable membrane probe allows for a controlled leak to the vacuum chamber, allowing sample to be transferred thereto while maintaining sufficient vacuum, e.g. under the influence of a vacuum pump. For example, the separator may comprise a membrane probe, e.g. a PDMS membrane in combination with a metal mesh, which is configured to control a flow of sample from the sample chamber to the vacuum chamber. For example, the control leak valve may be provided between the membrane probe and the vacuum chamber which has an opening having a diameter between 0.5 mm and 1 mm. Instead of a control leak valve, it is possible that an opening is provided between the membrane probe and the vacuum chamber.

In an embodiment of the second aspect the heatable separator comprises a heatable capillary inlet. Similarly, as for the membrane probe, the capillary inlet allows for a controlled leak to the vacuum chamber, allowing the sample to be transferred thereto. For example, the separator may comprise a heated capillary having a diameter between 10 micrometers and 100 micrometer for controlling a leak between the sample chamber and the vacuum chamber.

In embodiments of the second aspect of the measurement device, the heatable separator is heatable to at least 80° C., preferably to at least 100° C. It was found that for common samples, heating the heatable separator to at least 80° C., preferably to at least 100° C., prevents the sample from forming on the separator preventing the sample to be transferred to the vacuum chamber.

In embodiments of the measurement device, the first sensor is one of an infrared sensor, a Raman spectroscopy sensor, an ultraviolet-visible spectroscopy sensor, and a hyperspectral spectroscopy sensor. The type of first sensor may be chosen based on the type of sample measurement requirements, which may depend on sample features such as: transmittance, interactance, transflectance, diffuse transmittance, and diffuse reflectance.

In embodiments of the measurement device of the second aspect, the second sensor is one of a mass spectroscopy sensor, a gas chromatogram sensor, and a gas chromatogram-mass spectrum sensor. These sensors allow to determine a second property of the ionized sample, independent from the first property. The type of second sensor may be chosen based on the sample.

In embodiments of the measurement device of the second aspect, the vacuum chamber is configured for having a pressure between 10⁻⁵ and 10⁻⁷ mbar. In embodiments of the measurement device, the measurement device comprises a vacuum pump, e.g. for maintaining the vacuum through the controlled leak of the separator. The pressure of the vacuum chamber may be controlled by the vacuum pump.

In embodiments of the measurement device of the second aspect, the first sensor and/or the heater are located adjacent a sidewall or a lower wall of the sample chamber. The first sensor and the heater may both be located below the lower wall.

In embodiments of the measurement device of the second aspect, the sample holder comprises a mirror having a mirroring surface, and wherein the first sensor is provided opposite the mirroring surface when the sample holder is placed in the sample chamber. For example, the sample may be too transparent for the optical sensor to accurately determine the first property. A solution is to provide a mirror that reflects light from the optical sensor that has travelled through the substance back to the sensor such that the first property may be determined based on this light that has travelled through the sample. For example, when the optical sensor is provided below a lower wall of the sample chamber, the mirroring surface may be parallel to the lower wall when the sample holder is placed in the sample chamber. The mirror may be provided in a cavity in the sample holder that contains the sample.

The sample holder may comprise a transparent vial of e.g. borosilicate glass, Quarts glass or plastic.

In embodiments of the sample holder, the heater is configured to heat the sample to at least 400° C., preferably to at least 500° C. Depending on the sample, by heating the sample first volatile compounds may be vaporized from the sample and measured by the second sensor. By increasing the temperature less volatile compounds may be vaporized and measured by the second sensor. The sample may be heated to a temperature suitable for vaporizing interesting compounds therein. It was found that a temperature of at least 400° C., preferably to at least 500° C. may allow for vaporizing samples sufficiently. For example, the heater may be controlled to selectively vaporize compounds from the sample. For example, the heating may be ramped up slowly such that volatile compounds are vaporized. After or during vaporizing the volatile compounds, the heater may be ramped up more to vaporize less volatile compounds. For example, the heating may be ramped up between 40° C. and 400° C. per minute.

The second aspect is further related to a method for determining a presence of a chemical substance in a sample using simultaneous measurements on the sample, wherein use is made of a measurement device according to the invention.

In embodiments of the method of the second aspect, the method comprises:
placing the sample holder containing the sample in the sample chamber;
vaporizing a portion of the sample by heating it with the heater and transferring vaporized sample to the vacuum chamber;
ionizing the vaporized sample with the sample ionizer;
measuring simultaneously the sample in the sample holder using the first sensor and the vaporized sample in the vacuum chamber using the second sensor;
sending a first sample property obtained by measuring the sample with the first sensor to the processor and sending a second sample property obtained by measuring the sample with the second sensor to the processor;
determining, by the processor, a presence of a chemical substance in the sample based on the first sample property and the second sample property, wherein the presence of the chemical substance is determined when both the first sample property and the second sample property indicate the presence of the chemical substance; and
outputting, by the processor, the determined presence of the chemical substance.

In further embodiments of the method of the second aspect the heater is operated based on the first sample property, e.g. wherein a temperature change of the heater, e.g. from a first temperature to a vaporizing temperature, is based on the first sample property.

In embodiments of the method of the second aspect, wherein use is made of a measurement device wherein the sample transfer means comprise the sample ionizer, the method comprising:
placing the sample holder containing the sample in the sample chamber;
ionizing the sample using the sample ionizer;
transferring ionized sample from the sample chamber to the vacuum chamber by applying the electric potential;
measuring simultaneously the sample in the sample holder using the first sensor and the vaporized sample in the vacuum chamber using the second sensor;
sending a first sample property obtained by measuring the sample with the first sensor to the processor and sending a second sample property obtained by measuring the sample with the second sensor to the processor;
determining, by the processor, a presence of the chemical substance in the sample based on the first sample property and the second sample property; and
outputting, by the processor, the determined characteristic

In embodiments of the method of the second aspect, the method further comprises cleaning the separator before placing the sample holder in the sample chamber. The separator may become contaminated with sample reducing the reliability of the device. By cleaning the separator before using the device, the reliability of the device is improved.

The invention further relates to a method for determining a presence of a chemical substance, e.g. a drug, at a customs, e.g. at an airport, in a sample, wherein use is made of a measurement system according to the invention and/or the method according the invention.

### BRIEF DESCRIPTION OF THE DRAWINGS

The invention is explained below with reference to the drawing in which:

FIG. 1 shows a measurement system according to the first aspect;

FIG. 2a shows a sample chamber of the measurement system according to the first aspect;

FIG. 2b shows a top view of a sample holder in a coil;

FIG. 3 shows a sample evaporator;

FIG. 4 shows a measurement device according to the second aspect embodiment; and

FIG. 5 shows a measurement device according to the second aspect embodiment.

### DETAILED DESCRIPTION OF THE INVENTION

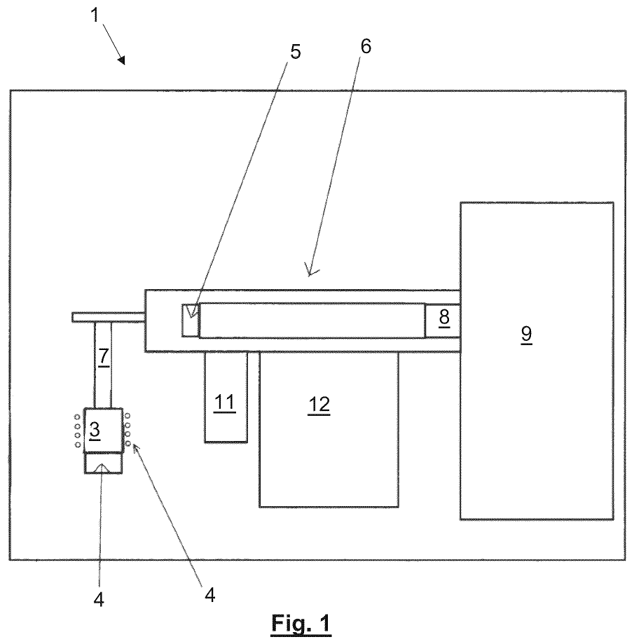

FIG. 1 shows a measurement system for determining a presence of a chemical substance in a sample. The measurement system comprises a measurement device 1 for receiving a sample holder 2 holding the sample. The measurement device 1 is depicted schematically in FIG. 1.

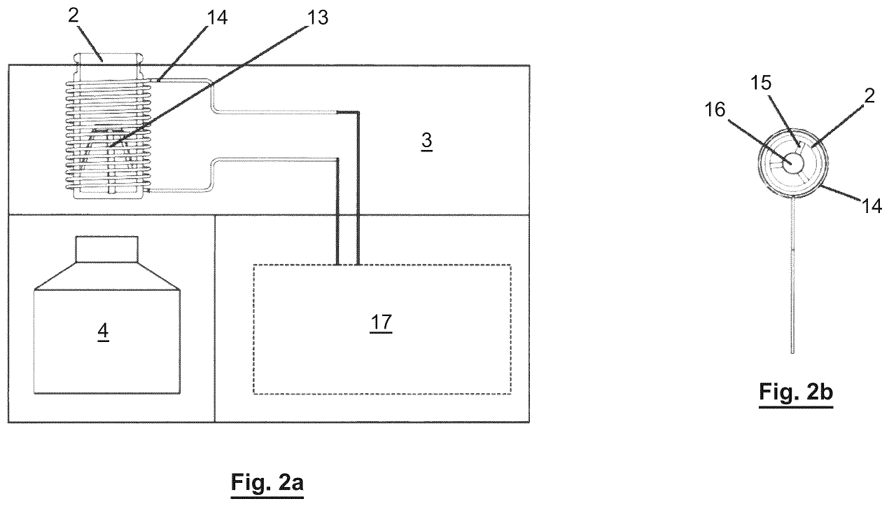

The measurement device 1 comprises a sample chamber 3 with an electromagnetic coil 14 for placing the sample holder 2 holding the sample in a center of the electromagnetic coil 14. For example, the sample chamber 3 may be removable from the measurement device 1, e.g. the sample chamber may be embodied as shown in FIG. 2a, to allow the sample holder 2 to be placed in the center of the electromagnetic coil 14. The sample chamber 3 may have an opening, e.g. closable by a door, e.g. in a top, bottom or side wall thereof, to allow the sample holder 2 to be placed in and removed from the sample chamber 3.

The electromagnetic coil 14 may be embodied as a regular or flat solenoid that surrounds the sample holder 2 when the sample holder 2 is placed in the sample chamber 3. The electromagnetic coil 14 is connected to electronic means 17 for providing an alternating electric current to the electromagnetic coil 14. This allows the formation of an alternating magnetic field in the sample chamber 3. By controlling the electric current in the coil 14, the magnetic field in the sample chamber 3 may be controlled, e.g. the field strength of the magnetic field may be controlled.

As shown in FIG. 2a, an optical sensor 4 may be provided adjacent to the sample chamber 3 for measuring a second sample property of the sample in the sample holder 2. In the embodiment of FIG. 2a, the sample holder 2 is placed in the centre of the electromagnetic coil 14 by placing the sample holder 2 from a top side of the sample chamber 3 into the center of the coil 14.

As shown in FIG. 2a, the measurement system comprises a sample holder 2, which in the drawing is embodied as a vial, for holding the sample therein. A magnetizable sample evaporator 13, i.e. a sample evaporator 13 that is magnetizable by the electromagnetic coil 14, is provided in the sample holder 2. The sample holder 2 has an opening in a top side thereof for providing the sample to the sample holder 2 in contact with the sample evaporator 13.

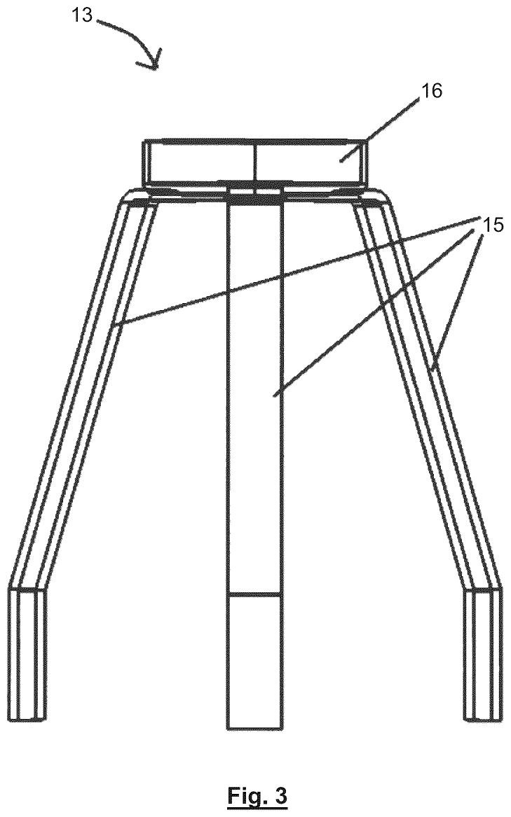

The sample evaporator 13, as shown in FIG. 2a, 2b and in more detail in FIG. 3, comprises three supporting legs 15 which support a magnetizable evaporator dish 16. The evaporator dish 16 is separated from a bottom of the sample holder 2 by the supporting legs 15. As can be seen from FIG. 2b, which shows a top view of the sample holder 2 in the magnetizable coil 14, when sample is deposited into the sample holder 2, a portion of the sample will fall onto the evaporator dish 16 and a portion of the sample will fall to the bottom of the sample holder 2. This allows the sample evaporator 13 to evaporate the portion of the sample that is deposited on the evaporator dish 16. For example, by choosing the dimensions of the evaporator dish 16, a quantity of evaporated sample may be controlled.

The measurement device 1 further comprises a vacuum chamber 6 that is adjacent to the sample chamber 3. The vacuum chamber 6 is configured for comprising a vacuum, e.g. by the action of a vacuum pump 12, wherein the pressure is measured by a pressure gauge 11.

The sample chamber 3 and vacuum chamber 6 are connected via sample transfer means. The sample transfer means comprise a separator 7 for separating the vacuum chamber 6 from the sample chamber 3. The separator 7 is porous to the evaporated sample such that sample evaporated in the sample chamber 3 may be transported through the separator 7.

The measurement device 1 comprises a sample ionizer 5 for ionizing evaporated sample, and an analytical spectrometry sensor 8 for determining a first sample property of the sample by performing a measurement on ionized evaporated sample in the vacuum chamber 6.

A processor 9 is connected to the electronic means 17 for controlling the alternating electric current provided to the electromagnetic coil 14 and connected to the spectrometry sensor 8 for receiving the first sample property and determining the presence of the chemical substance in the sample based on the first sample property.

The measurement system is configured to:
receive a sample in the sample holder 2 and receive the sample holder 2 in the sample chamber 3;
provide the alternating electric current to the electromagnetic coil 14 such that the electromagnetic coil 14 generates a magnetic field heating the sample evaporator 13, evaporating a portion of the sample in the sample holder 2 in contact with the sample evaporator 13;
transfer the evaporated sample through the sample transfer means to the spectrometry sensor 8 in the vacuum chamber 6;
ionize the evaporated sample with the sample ionizer 5;
measure the evaporated sample with the spectrometry sensor 8 to determine the first sample property;
determine the presence of the chemical substance in the sample by the processor 9 based on the first sample property; and
output, by the processor 9, the determined chemical substance.

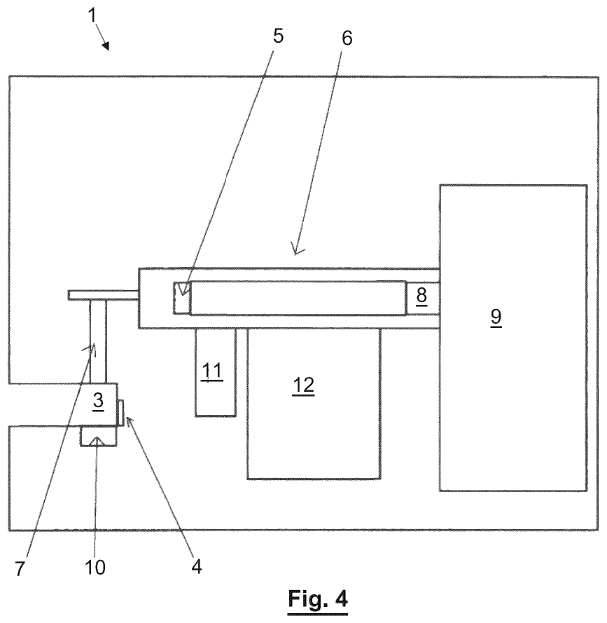

FIG. 4 shows a measurement device 1 of the second aspect for determining a presence of a chemical substance, e.g. a contraband, in a sample contained in a sample holder having an opening, wherein the measurement device 1 is configured to perform at least two simultaneous measurements on the sample. The measurements may be performed independent of each other due to the configuration of the measurement device 1.

The measurement device comprises a sample chamber 3 for placing the sample holder containing the sample. The sample chamber 3 of the embodiment shown in FIG. 1 is shown as a protrusion in the measurement device 1. An outer wall, e.g. a closable and openable outer wall, may be provided such that the sample chamber 3 is separable from the outside once a sample holder is placed in the sample chamber 3.

The sample chamber 3 is provided adjacent to a heater 10 which is provided below a lower wall of the sample chamber 3, for heating and vaporizing the sample in the sample holder. By heating the sample in the sample holder a portion of the sample may vaporize and be transferred towards the second sensor 8 for measuring. The heater 10 may be configured to heat the sample to at least 400° C., preferably to at least 500° C.

The measurement device 1 further comprises a first sensor 4 for performing a measurement on the sample in the sample holder and determining a first sample property. The first sensor 4 is an optical sensor provided adjacent to a side wall of the sample chamber 3. The first sensor 4 may be an infrared sensor, a Raman spectroscopy sensor, an ultraviolet-visible spectroscopy sensor, or a hyperspectral spectroscopy sensor.

The sample ionizer 5 is provided in the vacuum chamber 6 for ionizing the vaporized sample that has been transferred to the vacuum chamber 6. The sample ionizer 5 may be embodied as an ion source provided in the vacuum chamber 6. The vacuum chamber 6 comprises a vacuum, preferably having a pressure between 10⁻⁵ and 10⁻⁷ mbar, which pressure may be monitored by a pressure gauge 11 and maintained or created by a vacuum pump 12. For example, the sample chamber 3 may be provided with an opening in a wall, e.g. an upper wall, to which the vacuum chamber 6 is connected, e.g. via the heatable separator 7.

The measurement device 1 comprises a heatable separator 7 for separating the vacuum chamber 6 from the sample chamber 3. The heatable separator is porous to the sample and may comprise a valve for controlling a leak between the sample chamber 3 and the vacuum chamber 6. The sample transfer means are configured for transferring a portion of the sample, e.g. a vaporized portion of the sample, from the sample chamber 3 to the vacuum chamber 6. For example, the heatable separator 7 may comprise a heatable membrane probe comprising a membrane and a porous metal mesh, preferably having openings with a size in the range of 10 micrometer to 100 micrometer. In another example, the heatable separator 7 may comprise comprises a heatable capillary inlet. The heatable separator 7 may be heatable to 80° C., preferably to at least 100° C.

In the embodiment of FIG. 4, the second sensor 8 of the measurement device 1 is provided in the vacuum chamber 6. The second sensor 8 is configured to perform a second measurement on the ionized, by the sample ionizer 5, and vaporized, by the heater 10, sample. The second sensor 8 is an analytical spectrometry sensor, for example a mass spectroscopy sensor, a gas chromatogram sensor, and a gas chromatogram-mass spectrum sensor.

The first sensor 4 and the second sensor 8 are connected to a processor 9 for receiving the first sample property and the second sample property. The processor 9 is configured to determine a presence of a chemical substance in the sample based on the first property and the second property. For example, if both the first property and the second property indicate a certain molecular content of the sample, the processor 9 may determine that the sample has this molecular content, whereas if either one of the first property and the second property do not indicate the molecular content, then the processor may determine that the sample does not have this molecular content.

The measurement device of FIG. 4 may be used use is in a method comprising:
placing a sample holder containing the sample in the sample chamber 3;
vaporizing the sample by heating it with the heater 10;
ionizing the vaporized sample with the sample ionizer 5;
measuring simultaneously the sample in the sample holder using the first sensor 4 and the vaporized sample in the vacuum chamber 6 using the second sensor 8;
sending a first sample property obtained by measuring the sample with the first sensor 4 to the processor 9 and sending a second sample property obtained by measuring the sample with the second sensor 8 to the processor 9;
determining, by the processor 9, a presence of the chemical substance in the sample based on the first sample property and the second sample property; and
outputting, by the processor 9, the determined presence.

The heater 10 may be operated based on the first sample property, e.g. wherein a temperature change of the heater 10, e.g. from a first temperature to a vaporizing temperature, is based on the first sample property.

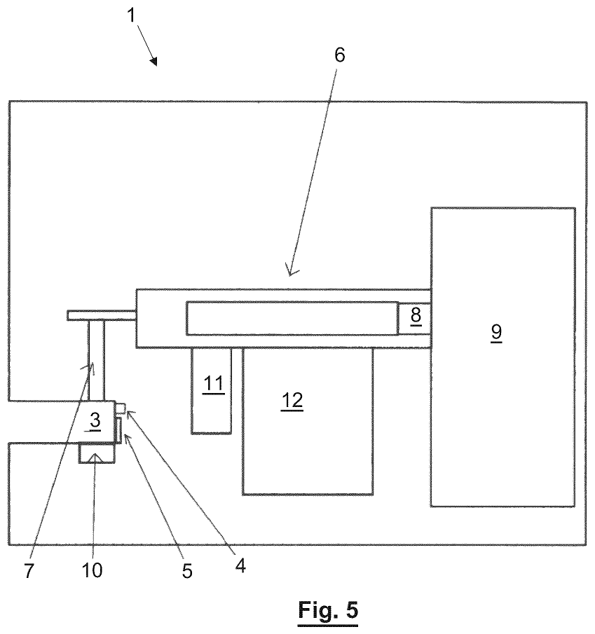

FIG. 5 shows a measurement device 1 of the second aspect, wherein the sample transfer means further comprises the sample ionizer 5 which is provided adjacent to the sample chamber 3. In other embodiments, the sample ionizer 5 may be provided inside the sample chamber 3. The sample ionizer 5 is configured to ionize the sample in the sample holder that is placed in the sample chamber 3. In this embodiment the heatable separator 7 comprises an ambient ionization probe for providing an electric potential to transfer the ionized sample from the sample chamber 3 to the vacuum chamber 6.

In the embodiment of FIG. 5 the sample is transferred to the vacuum chamber 6 by ionizing the, portion of, sample and then transferring the sample under the influence of an electric potential, e.g. an electric field, through the separator 7 which comprises an ambient ionization probe for providing the electric potential. For example, the ambient ionization probe may be a paperspray or an electrospray.

The measurement device 1 of FIG. 5 may be used in a method comprising:
placing the sample holder containing the sample in the sample chamber 3;
ionizing the sample using the sample ionizer 5;
transferring ionized sample from the sample chamber 3 to the vacuum chamber 6 by applying the electric potential;
measuring simultaneously the sample in the sample holder using the first sensor 4 and the vaporized sample in the vacuum chamber 6 using the second sensor 8;
sending a first sample property obtained by measuring the sample with the first sensor 4 to the processor 9 and sending a second sample property obtained by measuring the sample with the second sensor 8 to the processor 9;
determining, by the processor 9, a presence of a chemical substance in the sample based on the first sample property and the second sample property; and
outputting, by the processor, the determined presence.

The separator 7, or more generally the sample transfer means, may be cleaned before placing a new sample holder in the sample chamber 3 to prevent cross contamination between different samples, e.g. as a result of earlier sample sticking to the separator when a new sample is placed in the sample chamber.

### CLAUSES

The following are clauses related to the invention.
1. Measurement device for determining a presence of a chemical substance in a sample contained in a sample holder having an opening, wherein the measurement device is configured to perform at least two simultaneous measurements on the sample, wherein the measurement device comprises:
   a sample chamber for placing the sample holder containing the sample;
   a first sensor for performing a first measurement on the sample in the sample holder and measuring a first sample property indicative of the presence of the chemical substance in the sample, wherein the first sensor is an optical sensor provided adjacent to the sample chamber;
   a vacuum chamber configured for comprising a vacuum;
   a sample ionizer for ionizing the sample provided in the vacuum chamber;
   sample transfer means comprising a heatable separator provided between the vacuum chamber and the sample chamber, for separating the vacuum chamber (6) from the sample chamber, wherein the heatable separator is porous to the sample, wherein the sample transfer means are configured for transferring a portion of the sample from the sample holder through the separator to the vacuum chamber, wherein heating means are provided for heating the separator;
   a heater for heating and vaporizing the sample contained in the sample holder located in the sample chamber, wherein the heatable separator is porous to the vaporized sample.
   a second sensor for performing a second measurement on ionized sample in the vacuum chamber and measuring a second sample property indicative of the presence of the chemical substance in the sample, wherein the second sensor (8) is an analytical spectrometry sensor provided in the vacuum chamber; and
   a processor connected to the first sensor and the second sensor for receiving the first sample property and the second sample property and determining the presence of a chemical substance in the sample based on the first sample property and the second sample property,
wherein the measurement device is configured to:
   receive the sample in the sample holder and receive the sample holder in the sample chamber;
   vaporize a portion of the sample with the heater and transfer the vaporized sample to the vacuum chamber with the sample transfer means;
   simultaneously measure the first sample property with the first sensor and the second sample property with the second sensor; and
   determine the presence of the chemical substance in the sample based on the first sample property and the second sample property, wherein the presence of the chemical substance is determined when both the first sample property and the second sample property indicate the presence of the chemical substance.
2. Measurement device according to clause 1, wherein the heatable separator comprises a heatable membrane probe comprising a membrane and a porous metal mesh, preferably having openings with a size in the range of 10 micrometer to 100 micrometer.
3. Measurement device according to one or more of the preceding clauses, wherein the heatable separator comprises a heatable capillary inlet.
4. Measurement device according to one or more of the preceding clauses, wherein the heatable separator is heatable to at least 80° C., preferably to at least 100° C., by the heating means.
5. Measurement device according to one or more of the preceding clauses, wherein the first sensor is one of an infrared sensor, a Raman spectroscopy sensor, an ultraviolet-visible spectroscopy sensor, and a hyperspectral spectroscopy sensor.
6. Measurement device according to one or more of the preceding clauses, wherein the second sensor is one of a mass spectroscopy sensor, a gas chromatogram sensor, and a gas chromatogram-mass spectrum sensor.
7. Measurement device according to one or more of the preceding clauses, wherein the vacuum chamber is configured for having a pressure between 10⁻⁵ and 10⁻⁷ mbar.
8. Measurement device according to one or more of the preceding clauses, wherein the first sensor and/or the heater are located adjacent a sidewall or a lower wall of the sample chamber.
9. Measurement device according to one or more of the preceding clauses, wherein the sample holder comprises a mirror having a mirroring surface, and wherein the first sensor is provided opposite the mirroring surface when the sample holder is placed in the sample chamber.
10. Measurement device according to at least clause 2, wherein the heater is configured to heat the sample to at least 400° C., preferably to at least 500° C.
11. Method for determining a presence of a chemical substance in a sample using simultaneous measurements on the sample, wherein use is made of a measurement device according to one or more of the clauses 1-10.
12. Method according to clause 11, comprising:
   placing the sample holder containing the sample in the sample chamber;
   vaporizing a portion of the sample by heating it with the heater and transferring vaporized sample to the vacuum chamber;
   ionizing the vaporized sample with the sample ionizer;

What is claimed is:

1. A measurement system for determining a presence of a chemical substance in a sample, wherein the measurement system comprises a sample holder for holding the sample therein and a measurement device, wherein a magnetizable sample evaporator is provided in the sample holder, and wherein the sample holder has an opening in a top side thereof for providing the sample to the sample holder in contact with the sample evaporator,
wherein the measurement device comprises:
a sample chamber with an electromagnetic coil for placing the sample holder holding the sample in a center of the electromagnetic coil;
electronic means for providing an alternating electric current to the electromagnetic coil;
a vacuum chamber adjacent to the sample chamber, wherein the vacuum chamber is configured for comprising a vacuum;
sample transfer means for connecting the sample chamber to the vacuum chamber, wherein the sample transfer means comprise a separator provided between the vacuum chamber and the sample chamber for separating the vacuum chamber from the sample chamber, wherein the separator is porous to the evaporated sample, wherein the sample transfer means are configured to allow the evaporated sample to flow from the sample holder through the separator to the vacuum chamber;
a sample ionizer for ionizing the sample, which sample ionizer is provided in the vacuum chamber;
an analytical spectrometry sensor provided in the vacuum chamber for determining a first sample property of the sample by performing a measurement on ionized evaporated sample in the vacuum chamber; and
a processor connected to the electronic means for controlling the alternating electric current provided to the electromagnetic coil and connected to the spectrometry sensor for receiving the first sample property and determining the presence of the chemical substance in the sample based on the first sample property,
wherein the measurement system is configured to:
receive a sample in the sample holder and receive the sample holder in the sample chamber;
provide the alternating electric current to the electromagnetic coil such that the electromagnetic coil generates a magnetic field heating the sample evaporator, evaporating a portion of the sample in the sample holder in contact with the sample evaporator;
transfer the evaporated sample through the sample transfer means to the spectrometry sensor in the vacuum chamber;
ionize the evaporated sample with the sample ionizer;
measure the evaporated sample with the spectrometry sensor to determine the first sample property;
determine the presence of the chemical substance in the sample by the processor based on the first sample property; and
output, by the processor, the determined chemical substance.

2. The measurement system according to claim 1, wherein the sample evaporator comprises one or more supporting legs supporting a magnetizable evaporator dish which evaporator dish is separated from a bottom of the sample holder by the supporting legs, wherein the evaporator dish has a smaller cross section than a bottom of the sample holder such that a portion of sample received by the sample holder may be deposited on the evaporator dish and another portion of the sample may be deposited on the bottom of the sample holder.

3. The measurement system according to claim 1, wherein the sample holder comprises a sample vial for containing the sample and wherein the sample evaporator is provided in the sample vial.

4. The measurement system according to claim 1, wherein the electronic means for providing an alternating electric current to the electromagnetic coil comprises a power supply, an electronic oscillator and a capacitor.

5. The measurement system according to claim 1, wherein the measurement device further comprises a heater for heating the separator.

6. The measurement system according to claim 1, wherein the separator comprises a membrane probe comprising a membrane and a porous metal mesh, wherein the membrane allows evaporated sample to pass from the sample chamber to the vacuum chamber.

7. The measurement system according to claim 1, wherein the analytical spectrometry sensor is one of a mass spectroscopy sensor, a gas chromatogram sensor, and a gas chromatogram-mass spectrum sensor.

8. The measurement system according to claim 1, wherein the measurement device further comprises an optical sensor provided adjacent to the sample chamber for determining a second sample property by measuring the sample in the sample holder, wherein the processor is configured for receiving the second sample property and for determining the presence of the chemical substance in the sample based on the first sample property and the independently determined second sample property.

9. A method comprising the steps of:
determining a presence of a chemical substance in a sample using the measurement system according to claim 1.

10. The method according to claim 9, wherein the method comprises:
providing a sample in the sample holder and providing the sample holder in the sample chamber;
providing the alternating electric current to the electromagnetic coil such that the electromagnetic coil generates a magnetic field heating the sample evaporator, evaporating a portion of the sample in the sample holder in contact with the sample evaporator;
transferring the evaporated sample through the sample transfer means to the spectrometry sensor in the vacuum chamber;
ionizing the evaporated sample with the sample ionizer;
measuring the evaporated sample with the spectrometry sensor to determine the first sample property;
determining the presence of the chemical substance in the sample by the processor based on the first sample property; and
output, by the processor, the determined chemical substance.

11. The method according to claim 10, wherein use is made of a measurement system, wherein the further comprises: providing a portion of the sample received by the sample holder on the evaporator dish.

12. The method according to claim 10, wherein use is made of a measurement system, wherein the method further comprises:
measuring the sample in the sample holder with the optical sensor to determine the second sample property, wherein the measurement with the optical sensor is preferably performed simultaneously with the measurement of the spectrometry sensor; and
determining the presence of the chemical substance in the sample by the processor based on the first sample property and the second sample property.

13. (canceled)

14. The measurement system according to claim 1, wherein the sample holder is a vial, and wherein the sample evaporator is a metal sample evaporator.

15. The measurement system according to claim 2, wherein the sample evaporator comprises three supporting legs, and wherein the sample evaporator is a free-standing sample evaporator.

16. The measurement system according to claim 5, wherein the heater heats the separator to at least 80° C., or at least 100° C. or at least 220° C.

17. The measurement system according to claim 6, wherein the porous metal mesh has openings with a size in the range of 10 micrometer to 100 micrometer.

18. The measurement system according to claim 8, wherein the optical sensor is provided underneath the sample chamber.

19. The measurement system according to claim 2, wherein the sample holder comprises a sample vial for containing the sample and wherein the sample evaporator is provided in the sample vial, and wherein the electronic means for providing an alternating electric current to the electromagnetic coil comprises a power supply, an electronic oscillator and a capacitor.

20. The measurement system according to claim 19, wherein the measurement device further comprises a heater for heating the separator, and wherein the separator comprises a membrane probe comprising a membrane and a porous metal mesh, wherein the membrane allows evaporated sample to pass from the sample chamber to the vacuum chamber.

21. The measurement system according to claim 21, wherein the analytical spectrometry sensor is one of a mass spectroscopy sensor, a gas chromatogram sensor, and a gas chromatogram-mass spectrum sensor and wherein the measurement device further comprises an optical sensor provided adjacent to the sample chamber for determining a second sample property by measuring the sample in the sample holder, wherein the processor is configured for receiving the second sample property and for determining the presence of the chemical substance in the sample based on the first sample property and the independently determined second sample property.
